(19) United States
(12) Patent Application Publication
(10) Pub. No.: US 2026/0331679 A1
(43) Pub. Date: Oct. 22, 2026

(54) CELL ASSEMBLY AND BATTERY MODULE INCLUDING THE SAME, AND BATTERY PACK

(71) Applicant: LG ENERGY SOLUTION, LTD., Seoul (KR)

(72) Inventor: Sang Ok SEON, Daejeon (KR)

(21) Appl. No.: 19/113,856

(22) PCT Filed: Jul. 24, 2023
(86) PCT No.: PCT/KR2023/010672

§ 371 Date: Mar. 20, 2025

(30) Foreign Application Priority Data
Sep. 23, 2022 (KR) 10-2022-0121206

(51) Int. Cl. H01M 50/264; H01M 50/105; H01M 50/124; H01M 50/131; H01M 50/211

(52) U.S. Cl. CPC H01M 50/264; H01M 50/105; H01M 50/1245; H01M 50/131; H01M 50/211

(57) ABSTRACT

A cell assembly in which a plurality of battery cells are automatically aligned, a battery module comprising the cell assembly, and a battery pack comprising the battery module are provided. The cell assembly comprises the battery cells having magnets printed on surfaces thereof such that the battery cells are automatically aligned, the cells are prevented from being non-uniformly attached during the alignment, and physical positions of the battery cells are correctly located, thereby improving stacking workability.

### CROSS-REFERENCE TO RELATED APPLICATION

This application is a National Phase entry pursuant to 35 U.S.C. §371 of International Application No. PCT/KR2023/010672 filed on Jul. 24, 2023, and claims the benefit of the priority of Korean Patent Application No. 10-2022-0121206, filed on Sep. 23, 2022, the disclosures of which are incorporated herein by reference in their entirety.

### TECHNICAL FIELD

The present disclosure relates to an automatically aligned cell assembly, which has improved structure so as to automatically align cells, to prevent the cells from being non-uniformly attached during the alignment, and to correctly locate physical positions of the cells, and thereby improving stacking workability.

### BACKGROUND

In recent years, the price of energy sources increases due to the depletion of fossil fuels, the interest in environmental pollution is amplified, and the demand for eco-friendly alternative energy sources is becoming an indispensable factor for future life. Accordingly, studies on various power generation technologies such as solar power, wind power, and tidal power are continuing, and power storage devices such as batteries for more efficiently using the generated electrical energy are also of great interest.

Furthermore, as technology development and demand for electronic mobile devices and electric vehicles using batteries increase, the demands for batteries as energy sources are rapidly increasing. Thus, many studies on batteries which are capable of meeting various demands have been conducted.

Secondary batteries are receiving a lot of attention as an energy source in a variety of products such as mobile devices and electric vehicles. These secondary batteries are an excellent energy resource, which is capable of replacing the use of existing products using fossil fuels, and are attracting attention as an eco-friendly energy source because the secondary batteries do not generate by-products due to the energy use.

To manufacture such a secondary battery, a unit cell formed by stacking an electrode and a separator may be manufactured first, and the unit cell may be manufactured into a secondary battery through each process of the manufacturing process. The unit cells may be stacked during the manufacturing process to form a cell assembly, a battery module, and a battery pack, and thus, a process of aligning the unit cells may be required.

According to the related art, in the process of allowing the battery cells to overlap each other so as to manufacture the module, the cells may be fixed using a double-sided tape to prevent pouch cells from moving. However, in this process, when a machine misunderstands and mis-recognize a length of the cell, the cells may not be aligned consistently, and the misalignment may not be corrected.

### SUMMARY

The present disclosure is invented to solve the above problems, and an object of the present disclosure is to provide an automatically aligned cell assembly, which has improved structure so as to automatically align cells, to prevent the cells from being non-uniformly attached during the alignment, and to correctly locate physical positions of the cells, thereby improving stacking workability.

A cell assembly according to the present disclosure may be manufactured by stacking a plurality of cells. The cell assembly may include a first cell, which is one of the plurality of cells, and a second cell facing the first cell.

The first cell may include a first surface facing the second cell. The second cell may include a second surface facing the first surface.

A first magnet having a first polarity may be disposed on the first surface, and a second magnet having a second polarity that is opposite to the first polarity may be disposed on the second surface. The first magnet and the second magnet may be disposed at positions corresponding to each other, respectively.

A plurality of first magnets may be disposed on the first surface, and a plurality of second magnets may be disposed on the second surface. The plurality of first and second magnets may be disposed at corresponding positions, respectively.

A first′ (or first-prime) magnet having a second polarity may be further disposed on the first surface, and a second′ (or second-prime) magnet having a first polarity may be further disposed on the second surface. The first′ and second′ magnets may be disposed at positions corresponding to each other, respectively.

Each of the first surface and the second surface may be made of a pouch material, the first magnet may be printed on the first surface, and the second magnet may be printed on the second surface.

The second cell may further include a second′ surface disposed at a side opposite to the second surface, and at least one or more second'′ (or second-double prime) magnets may be disposed on the second′ surface.

The cell assembly may further include a third cell, which is one cell of the plurality of cells.

The third cell may include a third surface that faces the second′ surface, and a third magnet having a polarity opposite to that of the second″ magnet may be disposed at a position corresponding to the second″ magnet on the third surface.

A second′″ (or second-triple prime) magnet having a polarity that is opposite to that of the second″ magnet may be further disposed on the second′ surface, and a third′ magnet having a polarity that is opposite to that of the second′″ magnet may be further disposed on the third surface. The second′″ magnet and the third′ (or third-prime) magnet may be disposed at positions corresponding to each other, respectively.

The second magnet and the second″ magnet may be disposed at positions corresponding to each other, respectively, and the second′ magnet and the second′″ magnet may be disposed at positions corresponding to each other, respectively.

The second magnet and the second″ magnet may be disposed at different positions, respectively, and the second′ magnet and the second′″ magnet may be disposed at different positions, respectively.

Each of the second′ surface and the third surface may be made of a pouch material, the second″ magnet may be printed on the second′ surface, and the third magnet may be printed on the third surface.

A battery module according to the present disclosure may include a cell assembly, in which a plurality of cells are stacked, and a frame configured to accommodate the cell assembly.

A battery pack according to the present disclosure may a battery module including a cell assembly and a frame and a housing.

According to the present disclosure, the structure of the cell assembly may be improved by printing the magnet on each of the surfaces of the battery cells so as to automatically align the battery cells, to prevent the battery cells from being non-uniformly attached during the alignment, and to correctly locate physical positions of the cells, and thereby improving stacking workability.

### BRIEF DESCRIPTION OF THE DRAWINGS

FIG. 1 is a perspective view illustrating a cell assembly in which battery cells are stacked according to the present disclosure.

FIG. 2 is a cross-sectional view illustrating first and second cells in a cell assembly according to Example 1 of the present disclosure.

FIG. 3 is a cross-sectional view illustrating first and second cells in a cell assembly according to Example 2 of the present disclosure.

FIG. 4 is a cross-sectional view illustrating first and second cells in a cell assembly according to Example 3 of the present disclosure.

### DETAILED DESCRIPTION

Hereinafter, preferred embodiments of the present disclosure will be described in detail with reference to the accompanying drawings so that those of ordinary skill in the art may easily carry out the present disclosure. However, the present disclosure may be implemented in several different forms and is not limited or restricted by the following examples.

In order to clearly explain the present disclosure, detailed descriptions of portions that are irrelevant to the description or related known technologies that may unnecessarily obscure the gist of the present disclosure have been omitted, and in the present specification, reference symbols are added to components in each drawing. In this case, the same or similar reference numerals are assigned to the same or similar elements throughout the specification.

Also, terms or words used in this specification and claims should not be restrictively interpreted as ordinary meanings or dictionary-based meanings, but should be interpreted as meanings and concepts conforming to the scope of the present disclosure on the basis of the principle that an inventor may properly define the concept of a term to describe and explain his or her invention in the best ways.

The terms including the ordinal number such as “first”, “second”, “third” and those with prime symbol such as “second′ (or second-prime) ”, “second″ (or second-double prime)”, and “second′″ (or second-triple prime)” and the like, may be used to distinguish one element from another among various elements, but not intended to limit the elements by the terms.

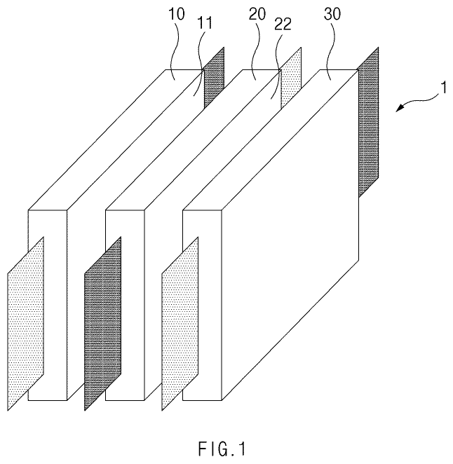

FIG. 1 is a perspective view illustrating a cell assembly in which battery cells are stacked according to the present disclosure.

Referring to FIG. 1, it is seen that battery cells are stacked to form a cell assembly 1. Hereinafter, the cell assembly 1 and a method for forming the cell assembly 1 of the present disclosure will be described through Examples 1, 2, and 3.

### Example 1

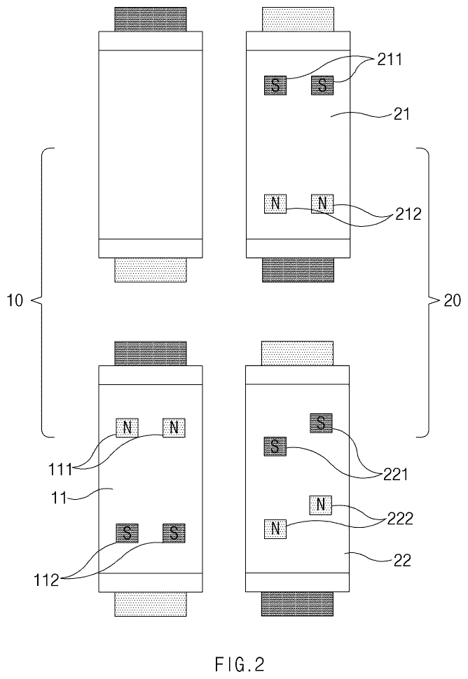

FIG. 2 is a cross-sectional view illustrating first and second cells in a cell assembly according to Example 1 of the present disclosure.

Referring to FIG. 2, a cell assembly 1 according to Example 1 of the present disclosure may include a first cell 10 and a second cell 20. The cell assembly 1 may be formed by stacking a plurality of cells. Referring to FIG. 2, a first surface 11 of the first cell 10 is illustrated at a left lower end, and a second surface 21, which is a surface facing the first surface 11, is illustrated at a right upper portion. A second′ (or second-prime) surface 22 is illustrated at a right lower end.

The first cell 10 may include the first surface 11. A first magnet 111 may be disposed on the first surface 11. The first surface 11 is illustrated as a rectangle, but the first surface 11 is not limited thereto and may have various shapes.

The first magnet 111 may have a first polarity. A plurality of first magnets 111 may be disposed on the first surface 11.

The second cell 20 may include the second surface 21. The second surface 21 may be disposed to face the first surface 11. The second surface 21 may have the same size as the first surface 11. A second magnet 211 may be disposed on the second surface 21. The second magnet 211 may have a second polarity. The second polarity may be opposite to the first polarity. A plurality of second magnets 211 may be disposed on the second surface 21. The first polarity and the second polarity may be arbitrarily designated, and the first polarity may be an N-pole or an S-pole, and correspondingly, the second polarity may also be an S-pole or an N-pole.

The second cell 20 may further include a second′ (or second-prime) surface 22. The second′ surface 22 may be disposed at an opposite side of the second surface 21. A second″ magnet 221 may be disposed on the second′ surface 22. At least one or more second″ (or second-double prime) magnets 221 may be disposed on the second′ surface 22. The second′ surface 22 may be provided in a shape corresponding to the second surface 21.

The first magnet 111 and the second magnet 211 may be disposed at corresponding positions, respectively. The first cell 10 and the second cell 20 may be disposed at corresponding positions so that the first cell 10 and the second cell 20 are well attached to each other. When forming the cell assembly 1, each of the first magnet 111 and the second magnet 211 is illustrated in a rectangular shape, but is not limited thereto.

A first′ magnet 112 may be further disposed on the first surface 11. The first′ magnet 112 may have a second polarity. Since the first magnet 111 and the first′ magnet 112 have different polarities, the first magnet 111 and the first′ magnet 112 may be disposed at regular intervals. A second′ magnet 212 may be further disposed on the second surface 21. The second′ magnet 212 may have a first polarity. Since the second magnet 211 and the second′ magnet 212 have different polarities, the second magnet 211 and the second′ magnet 212 may be disposed at regular intervals. The first′ magnet 112 and the second′ magnet 212 may be disposed at positions corresponding to each other, respectively. Although each of the first′ magnet 112 and the second′ magnet 212 is illustrated in the rectangular shape, the present disclosure is not limited thereto.

Each of the first surface 11 and the second surface 21 may be made of a pouch material. The second′ surface 22 may also be made of a pouch material. The first magnet 111 may be printed on the first surface 11. The second magnet 211 may be printed on the second surface 21. The first′ magnet 112 and the second′ magnet 212 may be printed on the surfaces of the first surface 11 and the second surface 21, respectively. The first magnet 111, the first′ magnet 112, the second magnet 211, and the second′ magnet 212 may be disposed to be printed on a surface of a pouch of the cell before constructing and manufacturing a negative electrode material, a positive electrode material, and a separator electrolyte in the pouch cell.

The present disclosure may include a battery module (not shown) including the cell assembly 1 according to Example 1 and a frame (not shown) accommodating the cell assembly 1.

The present disclosure may include a battery pack (not shown) including the battery module (not shown) including the cell assembly 1 according to Example 1 and a housing (not shown) accommodating the battery module.

According to the related art, in the process of allow the battery cells to overlap each other so as to manufacture the cell assembly and the module, the cells may be fixed using a double-sided tape to prevent the pouch cells from moving. However, in the process, when a machine mis-recognizes a length of the cell, and thus, the cells may not be aligned consistently so as to be misaligned, the misalignment may not be corrected. Referring to Example 1, in the present disclosure, when the cells are stacked and aligned, the cells may be aligned through the magnet printed on each of the cells. For example, when the first magnet 111 printed on the first surface 11 is the N-pole, the second magnet 211 that is the S-pole may be printed on the second surface 21 so that the first cell 10 and the second cell 10 are attached and aligned by the magnets. In addition, the first′ magnet 112 may be additionally printed on the first surface 11, and the second′ magnet 212 may be additionally printed on the second surface 21. If the first′ magnet 112 is the S-pole, the second′ magnet 212 may be printed as the N-pole, and thus, the first′ magnet 112 and the second′ magnet 212 may be coupled to each other to more increase in coupling force between the first cell 10 and the second cell 20. Since the magnet is not completely attached, it has a feature of being able to readjust the alignment of the cells when the cells are misaligned.

### Example 2

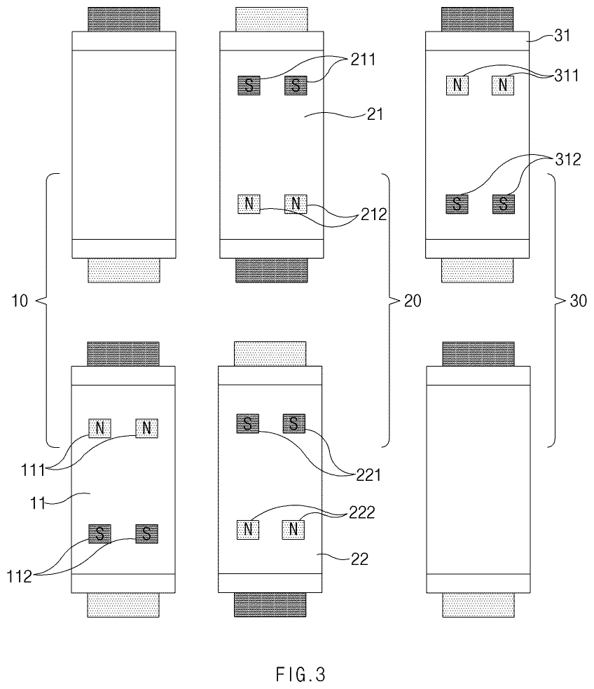

FIG. 3 is a cross-sectional view illustrating first and second cells in a cell assembly according to Example 2 of the present disclosure.

Example 2 of the present disclosure may be different from Example 1 in that a third cell 30 in addition to the first cell 10 and the second cell 20 is provided. The contents that are duplicated with Example 1 will be omitted as much as possible, and Example 2 will be described with a focus on the differences.

Referring to FIG. 3, a cell assembly 1 according to Example 2 of the present disclosure may further include the third cell 30.

The third cell 30 may include a third surface 31. The third surface 31 may face a second′ surface 22. A third magnet 311 may be disposed on the third surface 31. A plurality of third magnets 311 may be disposed on the third surface 31. The third surface 31 is illustrated in a rectangular shape, but is not limited thereto.

A second″ (or second-double prime) magnet 221 may be disposed on the second′ surface 22. The third magnet 311 may have a polarity opposite to that of the second″ magnet 221. The third magnet 311 may be disposed at a position corresponding to the second″ magnet 221.

A second′″ (or second-triple prime) magnet 222 may be further disposed on the second′ surface 22. The second′″ magnet 222 may have a polarity that is opposite to that of the second″ magnet 221. A plurality of second′″ magnets 222 may be disposed on the second′ surface 22.

A third′ magnet 312 may be further disposed on the third surface 31. The third′ magnet 312 may have a polarity opposite to that of the second′″ magnet 222. A plurality of third′ magnets 312 may be disposed on the third surface 31.

The second magnet 211 and the second″ magnet 221 may be disposed at positions corresponding to each other, respectively. The second′ magnet 212 and the second′″ magnet 222 may be disposed at positions corresponding to each other, respectively. Each of the third magnet 311, the third′ magnet 312, the second″ magnet 221, and the second′″ magnet 222 is illustrated in a rectangular shape, but is not limited thereto.

When compared to Example 1, in Example 2, a second′ surface 22 and a third cell 30 are additionally provided. The third surface 31 and the second′ surface 22 of the third cell 30 are attached by the magnets. As a result, the first cell 10, the second cell 20, and the third cell 30 may be attached to each other by the magnets to form the cell assembly 1, and the plurality of cells may be sequentially coupled to each other to form the cell assembly 1 include more cells.

### Example 3

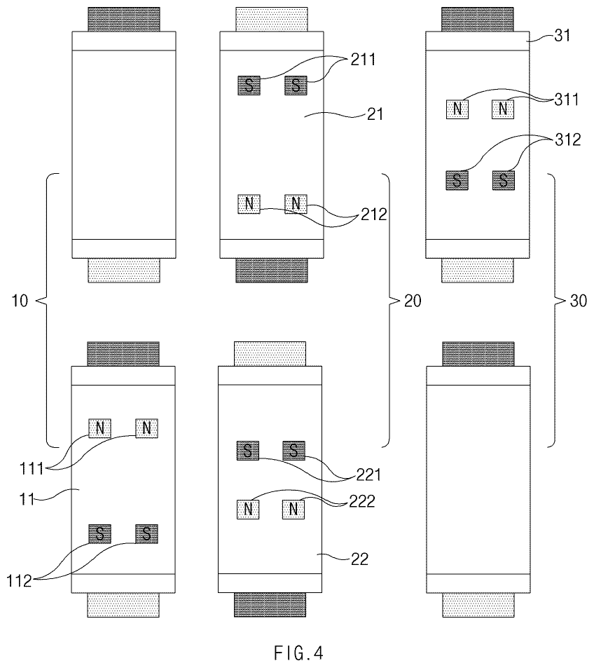

FIG. 4 is a cross-sectional view illustrating first and second cells in a cell assembly according to Example 3 of the present disclosure.

Example 3 of the present disclosure may be different from Example 2 in that magnets of a second cell 20 and a third cell 30 are disposed differently. The contents that are duplicated with Example 2 will be omitted as much as possible, and Example 3 will be described with a focus on the differences. That is, it is obvious that contents that are not described in Example 2 may be regarded as the contents of, Example 1 if necessary.

Referring to FIG. 4, a cell assembly 1 according to Example 3 of the present disclosure may further include the third cell 30. The third cell 30 may include a third magnet 311 and a third′ magnet 312. The second cell 20 may include a second″ magnet 221 and a second′″ magnet 222.

The second magnet 211 and the second″ magnet 221 may be disposed at different positions, respectively. The second′ magnet 212 and the second′″ magnet 222 may be disposed at different positions, respectively. The third magnet 311 and the third′ magnet 312 may be disposed on a third surface 31 to correspond to the positions of the second″ magnet 221 and the second′″ magnet 222.

When compared to Example 2, in Example 3, the second″ magnet 221, the second′″ magnet 222, the third magnet 311, and the third′ magnet 312 are disposed differently. This is because the positions of the second″ magnet 221 and the second′″ magnet 222 are different from those of the second magnet 211 and the second′ magnet 212 disposed on the second surface 21 to more increase in attractive force between the magnets. The second magnet 211 and the third magnet 311 have the same polarity, and the second′ magnet 212 and the third′ magnet 312 may also have the same polarity. Here, when the second magnet 211 and the third magnet 311 are disposed at the same position based on a direction perpendicular to the surface of the cell, the coupling force may be somewhat weakened due to the repulsive force between the magnets. To prevent this phenomenon, the positions at which the magnets are disposed may be changed, and an effect between the magnets may be reduced to strengthen the coupling force.

The magnets described above are not limited to specific magnet types and may be polarized magnetic materials.

While the embodiments of the present disclosure have been described with reference to the specific embodiments, it will be apparent to those skilled in the art that various changes and modifications may be made without departing from the spirit and scope of the disclosure as defined in the following claims.

### DESCRIPTION OF REFERENCE NUMERALS

1: Cell assembly
10: First cell
11: First surface
111: First magnet
112: First′ magnet
20: Second cell
21: Second surface
211: Second magnet
212: Second′ magnet
22: Second′ surface
221: Second″ magnet
222: Second′″ magnet
30: Third cell
31: Third surface
311: Third magnet
312: Third′ magnet

1. A cell assembly in which a plurality of cells are stacked, the cell assembly comprising:
a first cell that is one of the plurality of cells; and
a second cell that is another one of the plurality of cells and faces the first cell,
wherein the first cell comprises a first surface that faces the second cell, and
the second cell comprises a second surface that faces the first surface,
wherein a first magnet having a first polarity is disposed on the first surface, and
a second magnet having a second polarity that is opposite to the first polarity is disposed on the second surface, and
wherein the first magnet and the second magnet are disposed at positions corresponding to each other.

2. The cell assembly of claim 1, wherein a plurality of first magnets are disposed on the first surface, and a plurality of second magnets are disposed on the second surface,
wherein the plurality of first magnets and the plurality of second magnets are disposed at corresponding positions, respectively.

3. The cell assembly of claim 1, wherein a first′ magnet having a second polarity is further disposed on the first surface, and
a second′ magnet having a first polarity is further disposed on the second surface,
wherein the first′ magnet and the second′ magnet are disposed at corresponding positions, respectively.

4. The cell assembly of claim 1, wherein each of the first surface and the second surface is made of a pouch material,
wherein the first magnet is printed on the first surface, and
the second magnet is printed on the second surface.

5. The cell assembly of claim 1, wherein the second cell further comprises a second′ surface at a side opposite to the second surface, and
wherein one or more second″ magnets are disposed on the second′ surface.

6. The cell assembly of claim 5, wherein the cell assembly further comprises a third cell, which is one cell of the plurality of cells,
wherein the third cell comprises a third surface that faces the second′ surface, and
a third magnet having a polarity opposite to that of the second″ magnet is disposed at a position corresponding to the second″ magnet on the third surface.

7. The cell assembly of claim 6, wherein a second′″ magnet having a polarity that is opposite to that of the second″ magnet is further disposed on the second′ surface, and
a third′ magnet having a polarity that is opposite to that of the second′″ magnet is further disposed on the third surface,
wherein the second′″ magnet and the third′ magnet are disposed at positions corresponding to each other, respectively.

8. The cell assembly of claim 7, wherein the second magnet and the second″ magnet are disposed at positions corresponding to each other, respectively, and
the second′ magnet and the second′″ magnet are disposed at positions corresponding to each other, respectively.

9. The cell assembly of claim 7, wherein the second magnet and the second″ magnet are disposed at different positions, respectively, and
the second′ magnet and the second′″ magnet are disposed at different positions, respectively.

10. The cell assembly of claim 8, wherein each of the second′ surface and the third surface is made of a pouch material,
the second″ magnet is printed on the second′ surface, and
the third magnet is printed on the third surface.

11. A battery module comprising:
the cell assembly of claim 1; and
a frame accommodating the cell assembly.

12. A battery pack comprising:
the battery module of claim 11; and
a housing accommodating the battery module.

13. The cell assembly of claim 9, wherein each of the second′ surface and the third surface is made of a pouch material,
the second″ magnet is printed on the second′ surface, and
the third magnet is printed on the third surface.
